(19) United States
(12) Patent Application Publication
(10) Pub. No.: US 2025/0388346 A1
(43) Pub. Date: Dec. 25, 2025

(54) Unmanned Aircraft

(71) Applicant: ACSL Ltd., Tokyo (JP)

(72) Inventors: Hidenori Matsumoto, Tokyo (JP); Masahiro Yasuda, Tokyo (JP); Yusuke Kawai, Tokyo (JP); Hiroaki Ohta, Tokyo (JP)

(21) Appl. No.: 18/879,585

(22) PCT Filed: Jun. 30, 2022
(86) PCT No.: PCT/JP2022/026338

§ 371 Date: Jul. 24, 2025

(51) Int. Cl. B64U 10/16

(52) U.S. Cl. CPC B64U 10/16

(57) ABSTRACT

An unmanned aircraft including a horizontal wing and compact as a whole is provided.

An unmanned aircraft 100 includes an unmanned aircraft body 101, a plurality of rotors 104A, 104B, and 104C that have rotational axes extending in an up-down direction and are configured to enable the unmanned aircraft 100 to perform horizontal flight by controlling rotation of the plurality of rotors 104A, 104B, and 104C, and a wing body 106 provided above the unmanned aircraft body 101 and disposed to overlap at least part of rotational regions 104R of the plurality of rotors 104A, 104B, and 104C in a plan view.

### TECHNICAL FIELD

The present invention relates to an unmanned aircraft.

### BACKGROUND ART

A multicopter-type unmanned aircraft including a fuselage part housing electronic components and the like inside, a plurality of arm parts radially extending from the fuselage part in a plan view, and a plurality of propellers attached to distal ends of the arm parts with rotational axes extending in the up-down direction is known as an unmanned aircraft or what is called a drone. The multicopter-type unmanned aircraft performs horizontal movement by controlling rotation speeds of the plurality of propellers. When the multicopter-type unmanned aircraft performs horizontal movement at high speed, the output of the propellers need to be increased because an airframe experiences air resistance.

For example, Patent Literature 1 discloses an unmanned aircraft including a plurality of propellers and a horizontal wing, the plurality of propellers being attached with their rotational axes extending in the up-down direction. In addition, a VTOL-type unmanned aircraft including a horizontal wing, a propeller with its rotational axis extending in the up-down direction, and a propeller with its rotational axis extending in the front-back direction is known as an unmanned aircraft including a wing. According to such an unmanned aircraft including a horizontal wing, lift force can be generated using aerodynamics, and thus the output of the propellers can be reduced.

### CITATION LIST

### Patent Literature

[Patent Literature 1]
Chinese Patent Application Publication No. 110418753

### SUMMARY OF INVENTION

### Technical Problem

However, in VTOL-type unmanned aircrafts and the unmanned aircraft disclosed in Patent Literature 1, the horizontal wing laterally extends from the fuselage part, resulting in an overall lateral width that is extremely large. Accordingly, a large space is needed for storage, and transportation is cumbersome.

The present invention is made in view of the above-described problem and intended to provide an unmanned aircraft including a wing body and compact as a whole.

### Solution to Problem

An aspect of the present invention provides an unmanned aircraft including: an unmanned aircraft body; a plurality of rotor blades that have rotational axes extending in an up-down direction and are configured to enable the unmanned aircraft to perform horizontal flight by controlling rotation of the plurality of rotor blades; and a wing body provided above the unmanned aircraft body and disposed to overlap at least part of rotational regions of the plurality of rotor blades in a plan view.

In the aspect of the present invention, a sum of regions in which the wing body overlaps the rotational regions of the plurality of rotor blades in a plan view is equal to or smaller than 50% of a region of the wing body.

In the aspect of the present invention, the wing body is positioned on an inner side relative to the rotational regions of all rotor blades in a width direction and a front-back direction.

In the aspect of the present invention, the plurality of rotor blades include a back rotor blade provided at a back part of the unmanned aircraft, and the wing body has a shape not overlapping the rotational region of the back rotor blade in a plan view.

In the aspect of the present invention, the plurality of rotor blades include a front rotor blade provided at a front part of the unmanned aircraft, a center rotor blade provided at a center of the unmanned aircraft in the front-back direction, and a back rotor blade provided at a back part of the unmanned aircraft, and have shapes with which a sum of regions in which the wing body and the center rotor blade overlap each other in a plan view is larger than a sum of regions in which the front rotor blade and the center rotor blade overlap each other in a plan view and regions in which the back rotor blade and the center rotor blade overlap each other in a plan view.

In the aspect of the present invention, the wing body is held above the unmanned aircraft body by a plurality of rods.

In the aspect of the present invention, the wing body is provided such that a direction connecting a front edge and a back edge is inclined upward toward a front side.

In the aspect of the present invention, the wing body is provided to allow for change of an inclination angle of the wing body in the direction connecting the front and back edges.

In the aspect of the present invention, the wing body is configured such that, in a vertical section in the front-back direction, a distance along a contour of an upper surface from the front edge to the back edge is longer than a distance along a contour of a lower surface from the front edge to the back edge.

### Advantageous Effect of Invention

According to the present invention, it is possible to provide an unmanned aircraft including a wing body and compact as a whole.

### BRIEF DESCRIPTION OF DRAWINGS

FIG. 1 is a top perspective view illustrating a multicopter that is an example of an unmanned aircraft according to an embodiment of the present invention.

FIG. 2 is a front view illustrating the multicopter that is an example of the unmanned aircraft according to the embodiment of the present invention.

FIG. 3 is a side view illustrating the multicopter that is an example of the unmanned aircraft according to the embodiment of the present invention.

FIG. 4 is a plan view illustrating the multicopter that is an example of the unmanned aircraft according to the embodiment of the present invention.

FIG. 5 is a side view including an A-A section in FIG. 2, illustrating the multicopter that is an example of the unmanned aircraft according to the embodiment of the present invention.

FIG. 6 is a plan view illustrating, with circles, rotational regions of propellers in the unmanned aircraft according to the embodiment of the present invention.

FIG. 7 is a diagram illustrating a hardware configuration for flight control of the unmanned aircraft illustrated in FIG. 1.

FIG. 8 illustrates control command values and horizontal speed at each time in a comparative example, with the upper graph showing the control command values and the lower graph showing the horizontal speed.

FIG. 9 illustrates control command values and horizontal speed at each time in an example, with the upper graph showing the control command values and the lower graph showing the horizontal speed.

### DESCRIPTION OF EMBODIMENT

An embodiment of the present invention will be described below with reference to the accompanying drawings. However, the present invention is not limited to specific aspects described below but includes various kinds of aspects within the scope of the technological idea of the present invention. For example, the system configuration of an unmanned aircraft is not limited to that illustrated in the drawings but may be an optional configuration as long as the same operation is possible. For example, functions of a communication circuit may be integrated into a flight control unit, and operations executed by a plurality of constituent components may be executed by a single constituent component, or for example, functions of a main calculation unit may be distributed to a plurality of calculation units, and operations executed by a single constituent component may be executed by a plurality of constituent components. Moreover, various kinds of data stored in a memory of the unmanned aircraft may be stored in a place different from the memory, and as for information recorded in various memories, a single kind of information may be dispersively stored as a plurality of kinds or a plurality of kinds of information may be collectively stored as a single kind.

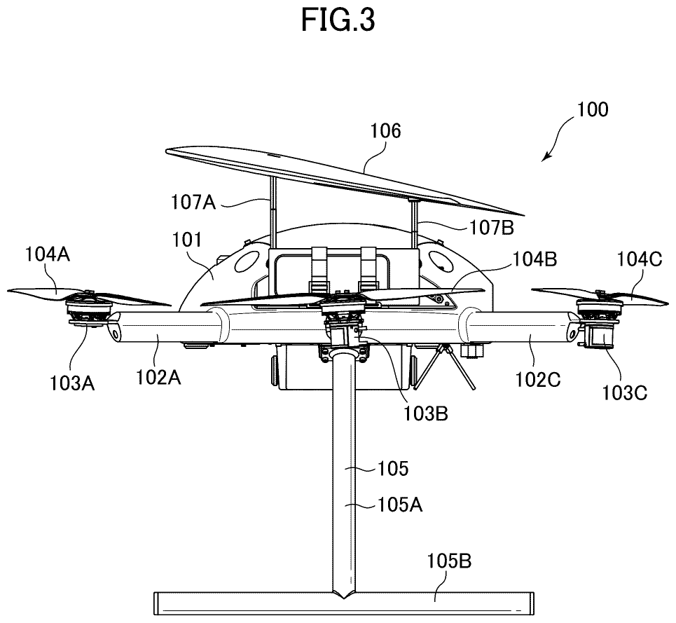

Note that the terms “horizontal direction”, “vertical direction”, and “up-down direction”, which are used in the following description, indicate directions with reference to a state in which the unmanned aircraft is landed on a horizontal surface. In addition, the term “front-back direction” defines a front side as being on the left side and a back side as being on the right side in FIG. 3. The front-back direction corresponds to the horizontal direction in a symmetric surface of a wing body.

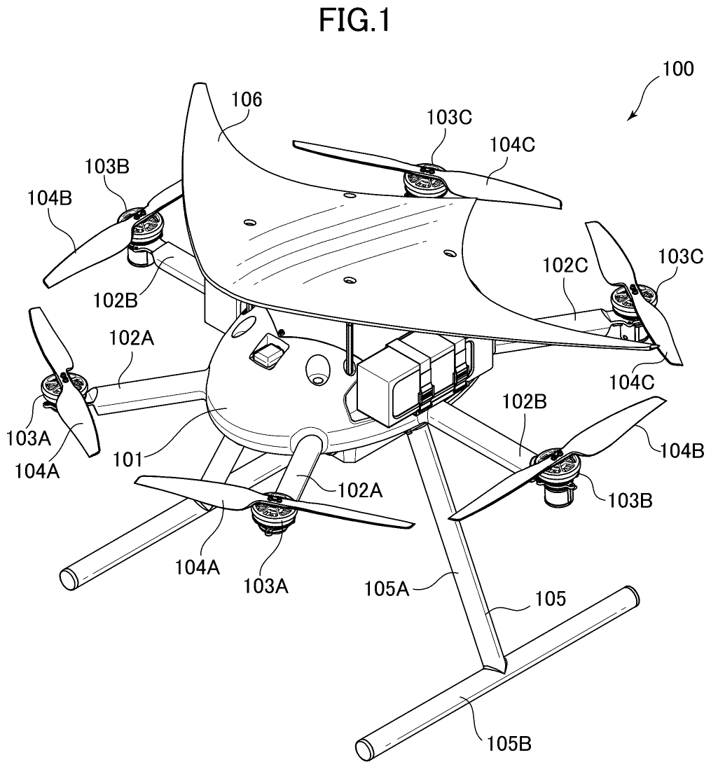

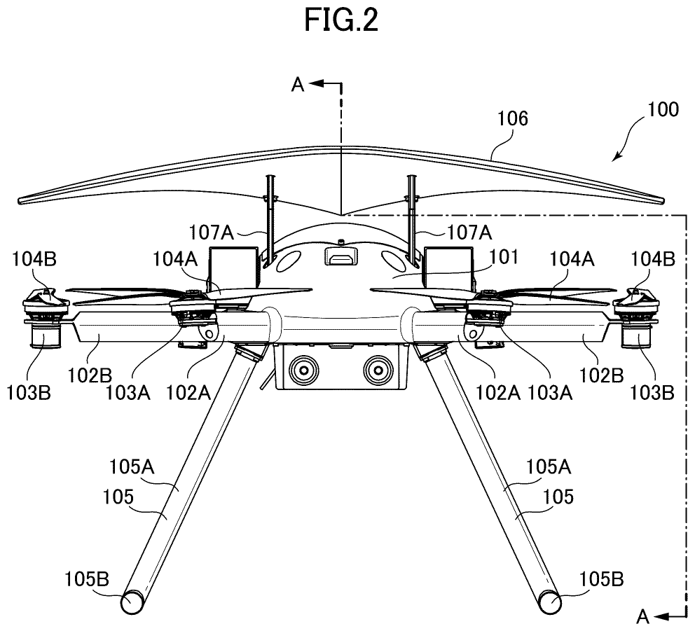

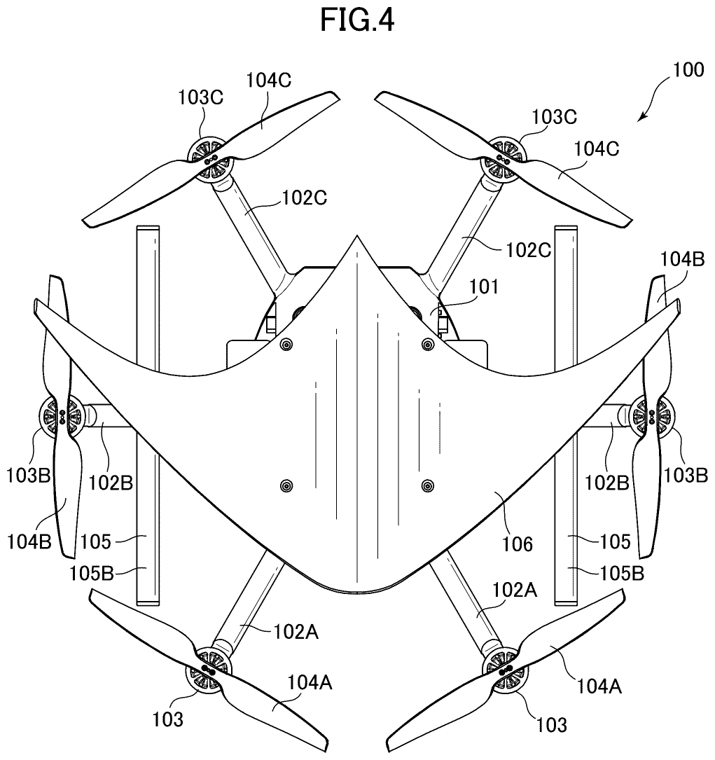

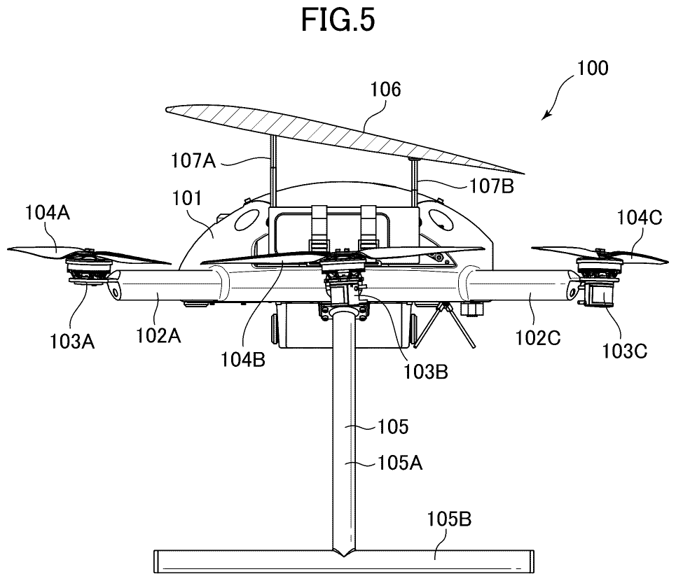

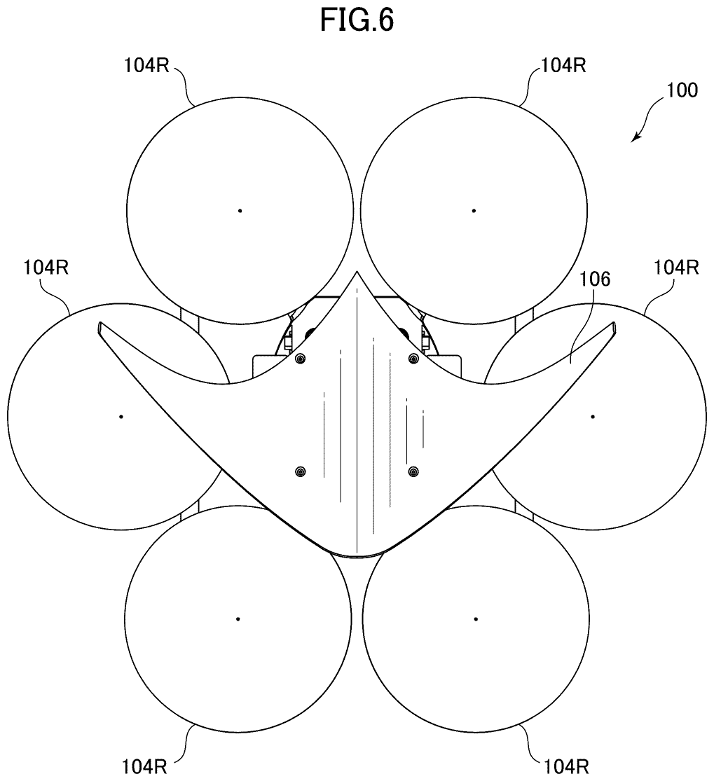

FIGS. 1 to 6 illustrate a multicopter that is an example of the unmanned aircraft according to the embodiment of the present invention. FIG. 1 is a top perspective view, FIG. 2 is a front view, FIG. 3 is a side view, FIG. 4 is a plan view, and FIG. 5 is a side view including an A-A section in FIG. 2. FIG. 6 is a plan view illustrating rotational regions of propellers with circles.

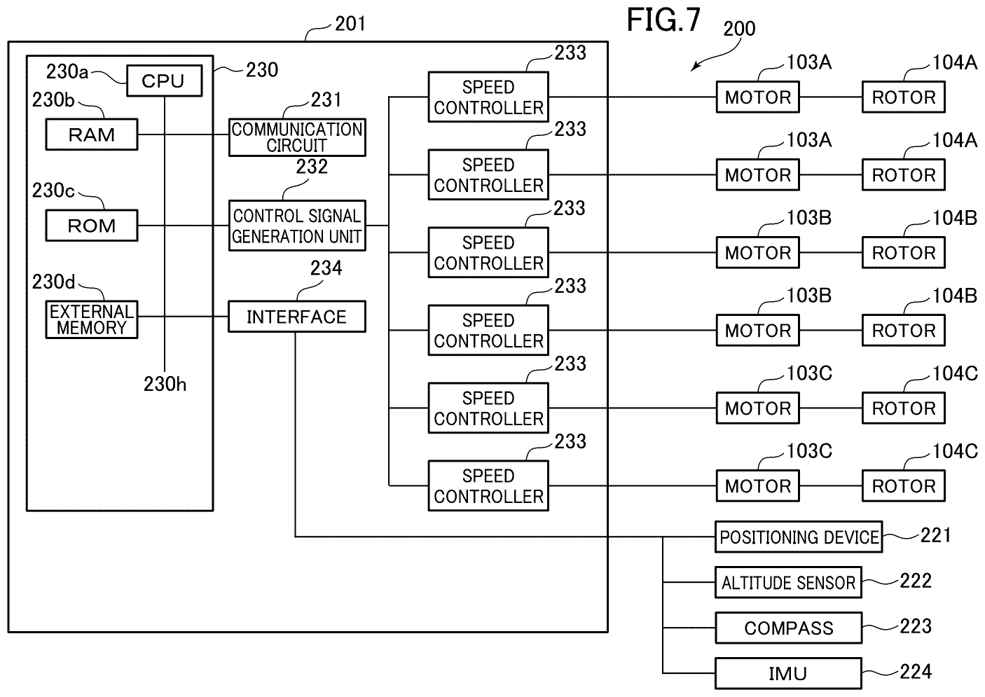

As illustrated in FIGS. 1 to 5, an unmanned aircraft 100 includes an unmanned aircraft body 101, six arms 102A, 102B, and 102C radially extending from the unmanned aircraft body 101, six motors 103A, 103B, and 103C connected to distal ends of the arms 102A, 102B, and 102C and driven by control signals from a control signal generation unit 232 controlled by an information processing unit 230 (FIG. 7), six rotors (rotor blades) 104A, 104B, and 104C rotated through drive of the respective motors 103A, 103B, and 103C to generate lift force, a pair of leg parts 105 that support the unmanned aircraft at landing, and a wing body 106 provided above the unmanned aircraft body 101. The numbers of the motors 103A, 103B, and 103C, the rotors 104A, 104B, and 104C, and the arms 102A, 102B, and 102C may be other than six, such as three or four. The rotation speeds of the six rotors 104A, 104B, and 104C are controlled as the six motors 103A, 103B, and 103C are rotated by control signals from the control signal generation unit 232 controlled by the information processing unit 230 (FIG. 7), and accordingly, flight of the unmanned aircraft 100 such as flight and rotation in the upward, downward, forward, backward, rightward, and leftward directions is controlled.

Note that the unmanned aircraft 100 of the present embodiment does not include propellers with horizontal rotational axes, as in what is called VTOL aircrafts, but moves forward by controlling rotation of the plurality of rotors 104A, 104B, and 104C with rotational axes extending in the up-down direction.

The unmanned aircraft body 101 is a housing that holds an information processing unit to be described later as well as a positioning device, an altitude sensor, a battery, an antenna, and the like.

The arms 102A, 102B, and 102C include the pair of front arms 102A extending from the unmanned aircraft body 101 toward the front side and spreading to the right and left, the pair of central arms 102B laterally extending from the unmanned aircraft body 101 to the right and left, and the pair of back arms 102C extending from the unmanned aircraft body 101 toward the back side and spreading to the right and left. The arms 102A, 102B, and 102C extend in the horizontal direction radially at equal angle intervals (60° intervals) in a plan view, and the positions of the rotors 104A, 104B, and 104C correspond to the apexes of a regular hexagon in a plan view.

Each leg part 105 includes a downward part 105A spreading outward laterally from the unmanned aircraft body 101, and a grounding part 105B orthogonally attached to the downward part 105A. The pair of grounding parts 105B extend in parallel, and when the grounding parts 105B make contact with a horizontal surface, the unmanned aircraft 100 can land such that the arms 102A, 102B, and 102C are horizontal.

The wing body 106 is supported above the unmanned aircraft body 101 by a pair of front support rods 107A and a pair of back support rods 107B extending upward from the unmanned aircraft body 101. The pair of front support rods 107A and the pair of back support rods 107B are made of metal rods. The spacing between the pair of front support rods 107A in the lateral direction is equal to the spacing between the pair of back support rods 107B in the lateral direction, and the pair of front support rods 107A and the pair of back support rods 107B are aligned in the front-back direction. The front support rods 107A and the back support rods 107B are attached to the unmanned aircraft body 101 such that the rods extend in the vertical direction in a state in which the unmanned aircraft 100 is landed. The front support rods 107A and the back support rods 107B have upper ends fixed to the wing body 106 by screws. The lengths of the front support rods 107A are longer than the lengths of the back support rods 107B, and accordingly, the wing body 106 is supported to the unmanned aircraft body 101 in a state in which a direction connecting a front edge and a back edge is inclined such that the front edge side is positioned upward.

In the present embodiment, the wing body 106 is provided on the unmanned aircraft body 101 to allow for change of an inclination angle of the direction connecting the front and back edges relative to the horizontal direction. Specifically, for example, to increase the inclination angle of the wing body 106, the front support rods 107A may be lengthened and/or the back support rods 107B may be shortened. For example, to decrease the inclination angle of the wing body 106, the front support rods 107A may be shortened and/or the back support rods 107B may be lengthened. A mechanism that changes the inclination angle is not limited to such a mechanism, and for example, a mechanism that changes the angle of the wing body by using a link mechanism or the like may be employed. In a case where a link mechanism is used, the inclination angle of the wing body 106 can be changed during flight by operating the link mechanism with an actuator. Note that the inclination angle of the wing body 106 may be changed in accordance with speed during forward movement.

The wing body 106 is formed of a material having a certain stiffness and a light weight, such as resin or carbon fiber.

As illustrated in FIG. 2, the wing body 106 is formed in a laterally symmetric shape in a front view. The wing body 106 has an upwardly convex curved shape protruding upward with a central part at its highest position and extending obliquely downward on both sides. The wing body 106 has side ends extending to above the distal ends of the central arms 102B and terminated on the inner side relative to rotational regions 104R of the rotors 104A, 104B, and 104C attached to the central arms 102B. In other words, the wing body 106 is positioned on the inner side relative to the rotational regions 104R of all rotors 104A, 104B, and 104C in the width direction.

As illustrated in FIG. 5, a vertical sectional shape of the wing body 106 in the front-back direction is what is called a wing shape. Specifically, the vertical sectional shape of the wing body 106 is a shape in which the back edge is sharper than the front edge and that has an upper surface bulging further than a lower surface. In other words, the distance along the contour of the upper surface of the wing body 106 from the front edge to the back edge is longer than the distance along the contour of the lower surface of the wing body 106 from the front edge to the back edge. The wing body 106 has a curved front edge in a front-back section and has streamlined upper and lower surfaces. The center of a front end of the wing body 106 is positioned above the vicinity of a front end of the unmanned aircraft body 101, and the center of a back end of the wing body 106 is positioned above the vicinity of a back end of the unmanned aircraft body 101 (the center of a back end of the wing body 106 protrudes on the back side slightly beyond a back end of the unmanned aircraft body 101). The center of the front end of the wing body 106 is positioned on the back side relative to the distal ends of the front arms 102A, and the back end of the wing body 106 is positioned on the front side relative to the distal ends of the back arms 102C. In other words, the wing body 106 is positioned on the inner side relative to the rotational regions 104R of all rotors 104A, 104B, and 104C in the front-back direction.

In a plan view, the front edge of the wing body 106 has a curved shape (V shape) protruding toward the front side at the center. The back edge of the wing body 106 has a curved shape protruding toward the front side on the right and left sides. The back end and both side ends of the wing body 106 at the center extend to the back side.

As illustrated in FIG. 6, the wing body 106 is disposed to partially overlap the rotational regions 104R of the rotors 104A, 104B, and 104C in a plan view. In the present embodiment, the wing body 106 overlaps part of the rotational regions of the rotors 104B attached to the front arms 102A and the central arms 102B in a plan view. In the present embodiment, since the back edge of the wing body 106 has a concave shape with a laterally symmetric circular arc, the wing body 106 does not overlap the rotational regions of the rotors 104C attached to the back arms 102C in a plan view. The sum of regions (horizontal projected areas) in which the rotational regions 104R of the rotors 104B attached to the central arms 102B overlap the wing body 106 in a plan view is larger than the sum of the regions in which the rotational regions 104R of the rotors 104A attached to the front arms 102A overlap the wing body 106 and the regions (horizontal projected areas) in which the rotational regions 104R of the rotors 104C attached to the back arms 102C overlap the wing body 106 in a plan view.

The sum of the horizontal projected areas of the regions in which the rotational regions of the rotors 104A, 104B, and 104C overlap the wing body 106 is preferably equal to or smaller than 50% of the horizontal projected area of the wing body 106.

A hardware configuration for flight control of the unmanned aircraft illustrated in FIG. 1 will be described below. FIG. 7 is a diagram illustrating the hardware configuration for flight control of the unmanned aircraft illustrated in FIG. 1. A flight control system 200 of the unmanned aircraft 100 includes a control unit 201, the motors 103A, 103B, and 103C, which are electrically connected to the control unit 201, the rotors 104A, 104B, and 104C, which are mechanically connected to the motors 103A, 103B, and 103C, and a positioning device 221, an altitude sensor 222, a compass 223, and an IMU 224, which are electrically connected to the control unit 201.

The control unit 201 is a component for performing information processing for performing flight control of the unmanned aircraft 100 and electric signal control therefor, and is typically a unit obtained by disposing and wiring various electronic components on a substrate to configure circuits necessary for achieving such functions. The control unit 201 further includes the information processing unit 230, a communication circuit 231, the control signal generation unit 232, speed controllers 233, and an interface 234.

The information processing unit 230 includes a CPU 230a, a RAM 230b, a ROM 230c, and an external memory 230d. The RAM 230b, the ROM 230c, the external memory 230d, the communication circuit 231, the control signal generation unit 232, and the interface 234 are connected to the CPU 230a through a system bus 230h.

The positioning device 221 is a navigation sensor such as a Global Positioning System (GPS) sensor, which senses the flight position coordinates of the unmanned aircraft 100. The positioning device 221 preferably senses three-dimensional coordinates. Note that the coordinates acquired by the positioning device 221 is constituted by latitude, longitude, and altitude.

The altitude sensor 222 is constituted by, for example, a barometer and estimates the altitude of the unmanned aircraft based on atmospheric pressure.

The compass 223 is what is called a magnetic compass and senses the angle of the front side of the unmanned aircraft 100 with respect to the north.

The IMU 224 is an inertial measurement unit and detects translational motion by an acceleration sensor and rotational motion by an angular velocity sensor (gyro). In addition, the IMU 224 can calculate a speed by integrating the translational motion (acceleration) detected by the acceleration sensor and can further calculate a travel distance (position) by integrating the speed. Similarly, the IMU 224 can calculate an angle (posture) by integrating the rotational motion (angular velocity) detected by the angular velocity sensor.

The communication circuit 231 is connected to, for example, an antenna. The antenna receives a radio signal including information and various kinds of data for operating and controlling the unmanned aircraft 100, and transmits a radio signal including a telemetry signal from the unmanned aircraft 100.

The communication circuit 231 is an electronic circuit for demodulating operation signals, control signals, various kinds of data, and the like for the unmanned aircraft 100 from a radio signal received through the antenna and inputting them to the information processing unit 230 and for generating radio signals that convey telemetry signals and the like output from the unmanned aircraft 100, and is typically a radio signal processing IC. Note that, for example, communication of operation signals and communication of control signals and various kinds of data may be executed by another communication circuit with a different frequency band. For example, it is also possible to adopt a configuration in which communication with a transmitter of a controller (proportional transmitter) for performing manual operation is performed at frequencies in the 950 MHz band and data communication is performed at frequencies in 2 GHz, 1.7 GHz, 1.5 GHz, and 800 MHz bands.

The control signal generation unit 232 is a component that converts control command value data obtained through calculation by the information processing unit 230 into pulse signals (such as PWM signals) representing voltage, and is typically an IC including an oscillation circuit and a switching circuit. Each speed controller 233 is a component that converts pulse signals from the control signal generation unit 232 into drive voltage that drives the motors 103A, 103B, and 103C, and is typically a smoothing circuit and an analog amplifier. Although not illustrated, the unmanned aircraft 100 is equipped with a power system including battery devices such as lithium polymer batteries and lithium ion batteries, as well as a power distribution system to components.

The interface 234 is a component that electrically connects the information processing unit 230 to functional elements such as the positioning device 221, the altitude sensor 222, and the compass 223 by converting the form of signals so that the signals can be transmitted and received between the information processing unit 230 and the functional elements. Note that the interface is illustrated as one component in the drawing for sake of explanation but it is normal to use any other interface depending on the kinds of functional elements to be connected. The interface 234 is unnecessary in some cases depending on the kinds of signals input and output by functional elements to be connected. Even when connected without the interface 234 in FIG. 7, the information processing unit 230 needs an interface in some cases depending on the kinds of signals input and output by functional elements to be connected.

The information processing unit 230 stores flight plan path data and controls drive of the motors 103A, 103B, and 103C based on the data so that the unmanned aircraft 100 flies along a predetermined flight path.

The flight plan path data is data indicating a flight plan path of the unmanned aircraft 100 and is typically data of a set of a plurality of waypoints located on the flight plan path. The flight plan path is typically a set of straight lines sequentially connecting the plurality of waypoints, but in a predetermined range of a waypoint, the path may be a curved line with a predetermined curvature. The flight plan path data may include data that determines flight speeds at a plurality of waypoints. The flight plan path data is typically used to determine the flight plan path during autonomous flight but may be used to guide flight during non-autonomous flight. The flight plan path data is typically input to and stored in the unmanned aircraft 100 before flight.

The control unit 201 controls flight of the unmanned aircraft along the flight plan path of the flight plan path data based on a self-position and a posture measured by the positioning device 221, the altitude sensor 222, the compass 223, and the IMU 224. Specifically, the control unit 201 calculates control command values for the rotors 104A, 104B, and 104C by determining the self-position, heading, posture, speed, and the like of the unmanned aircraft 100 with various sensors, determining the current flight position and heading of the unmanned aircraft 100 and the like based thereon, and comparing them with target values of an operation signal, a flight plan path (destination), a speed limit, an altitude limit, and the like, and outputs data indicating the control command values to a control signal generation unit 232. The control signal generation unit 232 converts the control command values into pulse signals representing voltage and transmits the pulse signals to the respective speed controllers 233. The speed controllers 233 convert the pulse signals into drive voltages and apply the drive voltages to the motors 103A, 103B, and 103C, and accordingly control drive of the motors 103A, 103B, and 103C and thus control the rotation speeds of the rotors 104A, 104B, and 104C, thereby controlling flight of the unmanned aircraft 100.

In the present embodiment, the information processing unit 230 functions as a flight control unit that performs flight control, but the flight control unit may be included in the unmanned aircraft by, for example, mounting these systems separately from the information processing unit 230. The flight control unit does not necessarily need to be configured by a single physical device but may be configured by a plurality of physical devices. The flight control unit may be configured as an optional appropriate device provided separately from the unmanned aircraft, such as a ground station computer, a PC, a smartphone, or a tablet terminal, a cloud computing system, or combination thereof. The function of each component of the self-position estimation system may be executed in a distributed manner by any one or a plurality of devices among one or a plurality of devices included in the unmanned aircraft and one or a plurality of devices provided separately from the unmanned aircraft.

When high-speed forward movement is performed by the unmanned aircraft 100, the information processing unit 230 outputs, to the control signal generation unit 232, data indicating control command values so that the rotation speeds of the back rotors 104C increase and the rotation speeds of the front rotors 104A decrease as compared to hovering. The control signal generation unit 232 converts the control command values into pulse signals representing voltage and transmits the pulse signals to the respective speed controllers 233. The speed controllers 233 convert the pulse signals into drive voltages and apply the drive voltages to the respective motors 103A, 103B, and 103C. Accordingly, the rotation speeds of the back rotors 104C become larger than the rotation speeds of the front rotors 104A and the unmanned aircraft body 101 assumes a forward inclined posture. Accordingly, lift force generated by the rotors 104A, 104B, and 104C is directed forward and upward and the unmanned aircraft 100 moves forward. In addition, the direction connecting the front and back edges of the wing body 106 becomes substantially horizontal as the unmanned aircraft body 101 assumes a forward inclined posture. Note that, in the present embodiment, the wing body 106 has an attachment angle adjusted so that the direction connecting the front and back edges of the wing body 106 becomes substantially horizontal during flight at 10 m per second or higher. As the unmanned aircraft 100 moves forward, an airflow from the front side toward the back side acts on the wing body 106, generating lift force on the wing body 106. Since lift force is generated by the wing body 106 in this manner, rotation speeds necessary for the rotors 104A, 104B, and 104C for forward movement decrease as compared to an unmanned aircraft not including the wing body 106.

The unmanned aircraft 100 of the present embodiment includes the unmanned aircraft body 101, the plurality of rotors 104A, 104B, and 104C attached to the unmanned aircraft body 101, and the wing body 106 provided above the unmanned aircraft body 101. According to such a configuration, since the wing body 106 is provided above the unmanned aircraft body 101, lift force can be generated by the wing body 106 during horizontal flight without an excessively large lateral width of the unmanned aircraft 100. Since lift force is generated by the wing body in this manner, the average rotation speeds (average outputs) of the rotors 104A, 104B, and 104C during forward movement decrease as compared to a case where an airframe not including the wing body 106 flies at the same speed.

In the present embodiment, the wing body 106 is disposed to overlap at least part of the rotational regions 104R of the plurality of rotors 104A, 104B, and 104C in a plan view. According to such a configuration, since the rotational regions 104R of the rotors 104A, 104B, and 104C overlap the wing body 106 in a plan view, it is possible to keep the unmanned aircraft 100 compact while increasing the area of the wing body 106. In the present embodiment, the sum of regions in which the wing body overlaps the rotational regions 104R of the plurality of rotors 104A, 104B, and 104C is equal to or smaller than 50% of the region of the wing body. According to such a configuration, regions in which the rotational regions 104R of the rotors 104A, 104B, and 104C overlap the wing body 106 are not excessively large, and it is possible to sufficiently reduce influence of the wing body 106 on lift force generated by the rotors 104A, 104B, and 104C, thereby reducing influence on flight of the unmanned aircraft 100.

According to the present embodiment, the wing body 106 is positioned on the inner side relative to the rotational regions 104R of all of the plurality of rotors 104A, 104B, and 104C in the width direction and the front-back direction. According to such a configuration, since the wing body 106 is positioned on the inner side relative to the rotational regions 104R of the rotors 104A, 104B, and 104C in a plan view, no large area for transportation and storage is needed because of no increase in the width direction and the front-back direction as compared to an airframe including no wing body.

During forward movement of the unmanned aircraft 100, the front rotors 104A positioned on the forward flight direction can smoothly draw in air as air flows from the front side, but the back rotors 104C are positioned on the back side relative to the wing body 106 and thus air inflow thereto potentially decreases due to influence of the wing body 106. However, according to the present embodiment, since the wing body 106 has a shape not overlapping the rotational regions 104R of the back rotors 104C in a plan view, influence of the wing body 106 on the back rotors 104C is reduced and air smoothly flows into the back rotors 104C.

According to the present embodiment, the sum of regions in which the rotational regions 104R of the rotors 104B attached to the central arms 102B overlap the wing body 106 in a plan view is larger than the sum of regions in which the rotational regions 104R of the rotors 104A attached to the front arms 102A overlap the wing body 106 and regions in which the rotational regions 104R of the rotors 104C attached to the back arms 102C overlap the wing body 106 in a plan view. According to such a configuration, it is possible to reduce the regions in which the rotational regions 104R of the rotors 104A attached to the front arms 102A overlap the wing body 106 and regions in which the rotational regions 104R of the rotors 104C attached to the back arms 102C overlap the wing body 106 in a plan view, thereby achieving stable flight during high-speed forward movement.

According to the present embodiment, the wing body 106 is held above the unmanned aircraft body 101 by the plurality of pairs of front support rods 107A and pairs of back support rods 107B. In a configuration where a horizontal wing is supported to the fuselage of an aircraft such as a VTOL-type aircraft, the horizontal wing is connected to the fuselage in a cantilever state. Thus, it is needed to firmly couple the horizontal wing to the fuselage to prevent damage on the horizontal wing even when a large aerodynamic resistance acts on the horizontal wing. However, in the present embodiment, since the wing body 106 is held above the unmanned aircraft body 101, the wing body 106 can be supported by simple components such as the pair of front support rods 107A and the pair of back support rods 107B, and no firm coupling structure is needed, which allows for weight reduction of the airframe.

When moving forward, an unmanned aircraft is inclined forward to obtain forward movement force with rotors. Thus, when moving forward, an unmanned aircraft not including the wing body 106 needs to increase the rotation speeds of rotors on the back side to be inclined forward. However, according to the present embodiment, the wing body 106 is provided such that the direction connecting the front and back edges is inclined upward toward the front side. Since the wing body 106 is inclined backward in this manner, the wing body 106 becomes substantially horizontal when the unmanned aircraft 100 is inclined forward to move forward, and accordingly, lift force acts substantially vertically. Then, as the unmanned aircraft 100 proceeds in the horizontal direction while the wing body 106 is substantially horizontal, stable airflows are generated on the upper and lower surfaces of the wing body 106, stabilizing the unmanned aircraft 100 in the forward inclined posture. Accordingly, it is possible to reduce the outputs of the back rotors 104C, thereby decreasing variance in the outputs of the rotors 104A, 104B, and 104C during horizontal flight as compared to an unmanned aircraft including no wing body.

Note that the wing body 106 is configured as one integrated member in the present embodiment but the present invention is not limited thereto. For example, a pair of wing bodies 106 may be provided on the front and back sides, or a plurality of wing bodies 106 may be vertically placed.

The inventors carried out a comparison experiment for an unmanned aircraft (hereinafter referred to as an example) including the wing body 106 described above and an unmanned aircraft (hereinafter referred to as a comparative example) including no wing body 106 nor support rods 107A and 107B, which will be described below.

In the comparison experiment, control command values output from the information processing unit to the control signal generation unit during flight at 10 m per second were recorded for the example and the comparative example. The control command values are proportional to the rotation speeds of the motors 103A, 103B, and 103C.

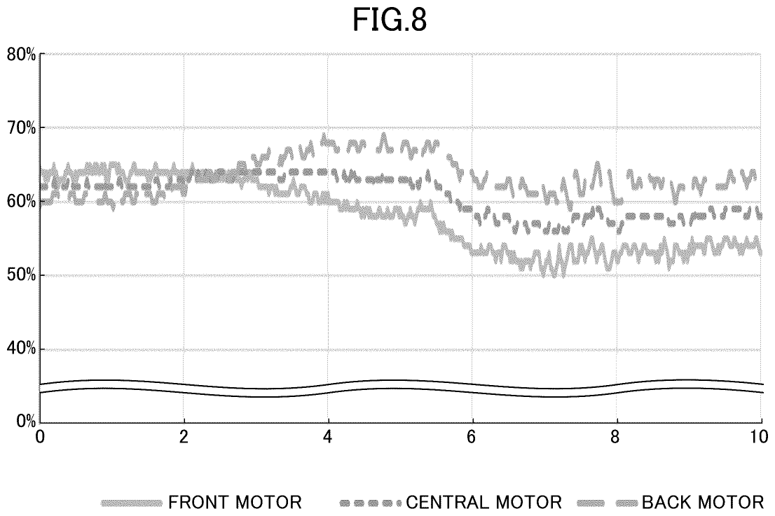

FIG. 8 illustrates the control command values of the front, central, and back motors at each time in the comparative example. In FIG. 8, the vertical axis represents the average values of the control command values of the front, central, and back motors, each averaged over the right and left motors, and the horizontal axis represents time (second). In the graph of the comparative example, hovering is performed during 0 to 2 seconds, followed by acceleration after elapse of 2 seconds, and then constant speed flight is performed at the horizontal speed of 10 m/s.

In the comparative example, the average values of the outputs of the motors 103A, 103B, and 103C when flight is performed at the horizontal speed of 10 m/s are approximately 58%, the outputs of the back motors 103C are extremely large as compared to the outputs of the central motors 103B, and the outputs of the front motors 103A are extremely small as compared to the outputs of the central motors 103B.

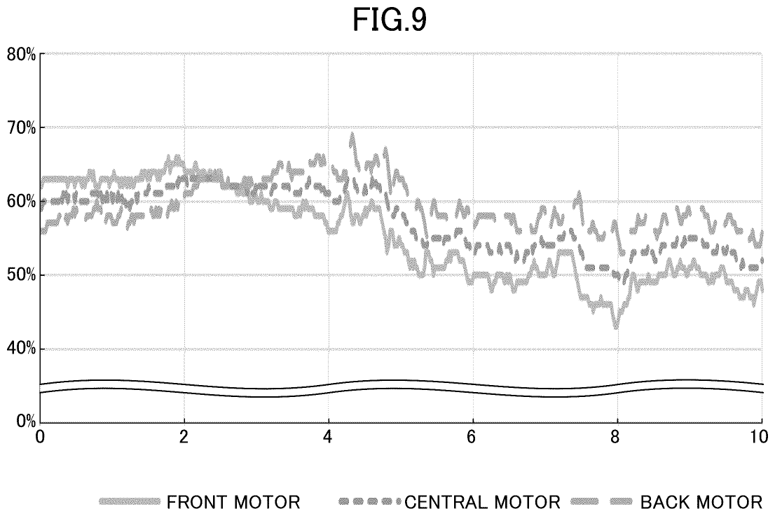

FIG. 9 illustrates the control command values of the front, central, and back motors at each time in the example. In FIG. 9, the vertical axis represents the average values of the control command values of the front, central, and back motors, each averaged over the right and left motors, and the horizontal axis represents time (second). In the graph of the example, hovering is performed during 0 to 2 seconds, followed by acceleration after elapse of 2 seconds, and then constant speed flight is performed at the horizontal speed of 10 m/s.

According to the example, the average values of the outputs of the motors 103A, 103B, and 103C when flight is performed at the horizontal speed of 10 m/s are approximately 52%, which is small as compared to the comparative example in which no wing body 106 is included.

As for variance in the outputs of the motors 103A, 103B, and 103C when flight is performed at the horizontal speed of 10 m/s, variance in the outputs of the back motors 103C and the front motors 103A in the example is small as compared to the comparative example.

In this manner, it was confirmed that according to the example, variance in the outputs of the motors is small as compared to the comparative example in which no wing body is included, and moreover, necessary outputs of the motors during high-speed flight are small as compared to the comparative example.

### REFERENCE SIGNS LIST

100 unmanned aircraft
101 unmanned aircraft body
102A, 102B, 102C arm
103A, 103B, 103C motor
104A, 104B, and 104C rotor
104R rotational region
105 leg part
105A downward part
105B grounding part
106 wing body
107A front support rod
107B back support rod
132 control signal generation unit
200 flight control system
201 control unit
221 positioning device
222 altitude sensor
223 compass
230 information processing unit
230a CPU
230b RAM
230c ROM
230d external memory
230h system bus
231 communication circuit
232 control signal generation unit
233 speed controller
234 interface

1. An unmanned aircraft comprising:
an unmanned aircraft body;
a plurality of rotor blades that have rotational axes extending in an up-down direction and are configured to enable the unmanned aircraft to perform horizontal flight by controlling rotation of the plurality of rotor blades; and
a wing body provided above the unmanned aircraft body and disposed to overlap at least part of rotational regions of the plurality of rotor blades in a plan view.

2. The unmanned aircraft according to claim 1, wherein a sum of regions in which the wing body overlaps the rotational regions of the plurality of rotor blades in a plan view is equal to or smaller than 50% of a region of the wing body.

3. The unmanned aircraft according to claim 1, wherein the wing body is positioned on an inner side relative to the rotational regions of all rotor blades in both a width direction and a front-back direction.

4. The unmanned aircraft according to claim 1, wherein
the plurality of rotor blades include a back rotor blade provided at a back part of the unmanned aircraft, and
the wing body has a shape not overlapping the rotational region of the back rotor blade in a plan view.

5. The unmanned aircraft according to claim 1, wherein the plurality of rotor blades
include a front rotor blade provided at a front part of the unmanned aircraft, a center rotor blade provided at a center of the unmanned aircraft in a front-back direction, and a back rotor blade provided at a back part of the unmanned aircraft, and
have shapes with which a sum of regions in which the wing body and the center rotor blade overlap each other in a plan view is larger than a sum of regions in which the front rotor blade and the center rotor blade overlap each other in a plan view and regions in which the back rotor blade and the center rotor blade overlap each other in a plan view.

6. The unmanned aircraft according to claim 1, wherein the wing body is held above the unmanned aircraft body by a plurality of rods.

7. The unmanned aircraft according to claim 1, wherein the wing body is provided such that a direction connecting a front edge and a back edge is inclined upward toward a front side.

8. The unmanned aircraft according to claim 7, wherein the wing body is provided to allow for change of an inclination angle of the wing body in the direction connecting the front and back edges.

9. The unmanned aircraft according to claim 1, wherein the wing body is configured such that, in a vertical section in a front-back direction, a distance along a contour of an upper surface from a front edge to a back edge is longer than a distance along a contour of a lower surface from the front edge to the back edge.
